(19) United States
(12) Patent Application Publication
(10) Pub. No.: US 2018/0272999 A1
(43) Pub. Date: Sep. 27, 2018

(54) OPTICAL DETECTION SYSTEM FOR MOTOR VEHICLE AND METHOD FOR CLEANING THE LENS OF THE OPTICAL DETECTION SYSTEM

(71) Applicant: Valeo Systèmes d'Essuyage, Le Mesnil Saint Denis (FR)

(72) Inventors: Frédéric Giraud, Le Mesnil Saint Denis (FR); Giuseppe Grasso, Le Mesnil Saint Denis (FR); Marcel Trebouet, Le Mesnil Saint Denis (FR)

(73) Assignee: Valeo Systèmes d'Essuyage, Le Mesnil Saint Denis (FR)

(21) Appl. No.: 15/760,163

(22) PCT Filed: Aug. 2, 2016
(86) PCT No.: PCT/EP2016/068364

§ 371 Date: Mar. 14, 2018

(30) Foreign Application Priority Data
Sep. 14, 2015 (FR) 1558566

(51) Int. Cl. B60S 1/56; B60S 1/50; B60S 1/48; B60S 1/54; B60S 1/52

(52) U.S. Cl. CPC B60S 1/56; B60S 1/50; B60S 1/52; B60S 1/54; B60S 1/488

(57) ABSTRACT

The invention relates to an optical detection system (1) of a motor vehicle comprising:—an optical sensor module (3),—a cleaning system (5) for cleaning the optical sensor module (3) and comprising at least a main reservoir (21) of a washing liquid and at least one liquid-spray nozzle (35) connected to the said main reservoir (21), characterized in that it comprises an additional reservoir (37) of a rinsing liquid arranged in parallel with the first reservoir (21) and fluidically connected to the said at least one spray nozzle (35).

The present invention relates to an optical detection system for a motor vehicle and to a method for cleaning the lens of the optical detection system. Any system including optical sensors, such as cameras, laser sensors (commonly called LIDAR sensors) or other sensors based on the emission and/or the detection of the light in the spectrum, visible or invisible to humans, in particular infrared light, is called optical detection system.

Nowadays, vision cameras, in particular rear view cameras, equip a large number of current motor vehicles and are in particular a part of a park assist system which makes it possible to park more easily in a space without turning round and to detect objects situated behind the vehicle.

Cameras are known which are installed inside the passenger compartment against the rear window/pane and pointing to the rear from the rear window of the vehicle. These cameras are well protected from external climatic influences and can for example benefit from systems for de-icing and cleaning the rear window, for example, from a heating wire integrated into the glass of the rear window.

However, the viewing angle is not optimum, in particular for a park assist system, and for this reason, it is preferred for the camera to be disposed at the rear bumper or at the rear license plate of the vehicle.

In this case, the camera is therefore highly exposed to projections of dirt which can be deposited on its lens and thus reduce its efficiency, and even make it inoperable.

In rainy weather in particular, projections of rain and dirt are found which can significantly affect the operability of the optical detection system.

In order to counter deposits of dirt on the camera, the disposition of a device for cleaning the lens of the camera is known, generally an atomizer of cleaning liquid close to it, in order to eliminate the contaminating elements which have been deposited over time.

Likewise, in cold weather, ice can be deposited on the lens of the camera, making it inoperable.

A known prior art is for example disclosed by the document FR2841488 wherein an atomizer sprays for example a pressurized washing liquid onto a pane for protecting the camera. The atomizer is furthermore assisted by vibration means making it possible to remove stubborn dirt from the pane for protecting the camera, pane which can be heated to protect it against deposits of ice in cold weather.

However, it has been found that the functioning of this vision system can be optimized. In effect, after a washing liquid has been sprayed onto the camera lens, drops can still cling to the protective pane, which spoils and deforms the image taken by the camera. The presence of the drops of washing liquid results from the fact that the washing liquid does not slide easily over the surface of the camera lens. Furthermore, the evaporation of drops on the protective pane leaves marks which can be seen on the image taken by the camera.

Given that the cameras used are smaller and smaller, the size of the clinging drops becomes significant compared with the surface of the protective pane and can significantly impair the image captured by the camera.

In order to resolve this problem, the document DE10332939 proposes for example to spray a high pressure jet of air onto the lens to chase away the last clinging drops of water.

However, this solution necessitates an additional high pressure air compressor with a dedicated air filtering system which is complex and costly. Furthermore, such a compressor generates noise which can be felt to be annoying by the passengers in the vehicle.

The present invention proposes at least partially to remedy one or more of the abovementioned disadvantages by offering an alternative optical detection system making it possible in a general manner to improve cleaning of the camera exposed to diverse soiling.

To that effect, the object of the invention is an optical detection system for a motor vehicle, comprising:
an optical sensor module,
a system for cleaning the optical sensor module including at least one main reservoir of a washing liquid and at least one spray nozzle of a liquid connected to said main reservoir,
   characterized in that it comprises an additional reservoir of a rinsing liquid arranged in parallel with the main reservoir and fluidically connected to said at least one spray nozzle.

Thanks to the rinsing liquid, a more efficient cleaning action of the lens of the optical detection system is obtained and all washing liquid can be evacuated in an efficient manner.

In the case where the rinsing liquid is additionally heated, the evaporation can be accelerated and the optical detection system is more rapidly operable after washing. Furthermore, a temperature increase of the rinsing liquid changes its physical properties and increases its fluidity, therefore its rinsing capability.

The optical detection system according to the invention can include one or more of the following characteristics taken alone or combined:

The optical sensor module can include a housing, an optical sensor accommodated in the housing and a lens arranged in front of the optical sensor and forming at least part of the wall of the housing.

The rinsing liquid comprises for example surface active agents or surfactants.

According to one aspect, the optical detection system furthermore comprises an air compressor whose outlet is also connected via a conduit to said at least one spray nozzle.

According to another aspect, the optical detection system comprises at least one means for heating the rinsing liquid.

The heating means can be arranged in said additional reservoir of the rinsing liquid.

According to a variant, the optical detection system comprises an intermediate reservoir, an inlet of which is connected to an outlet of said additional reservoir and an outlet of which is connected to said at least one spray nozzle, the intermediate reservoir being smaller in size than the additional reservoir and the heating means is arranged in said additional reservoir.

The heating means comprises for example an immersion heater.

The heating means can be arranged in a fluidic conduit connecting the additional reservoir to said at least one spray nozzle.

The fluidic conduit connecting the additional reservoir to said at least one spray nozzle is for example embodied in an elastomer material and comprises at least one resistive wire integrated at least in a longitudinal portion of the elastomer material of the fluidic conduit and forming the means for heating the liquid circulating in the fluidic conduit.

The invention also relates to a method for cleaning the lens of an optical detection system such as that described above, characterized in that it comprises the following steps:
a washing liquid is sprayed onto the lens of the optical sensor module, and
a rinsing liquid is sprayed onto the lens of the optical sensor module.

Other advantages and characteristics will emerge on reading the description of the invention, as well as the attached drawings, on which:

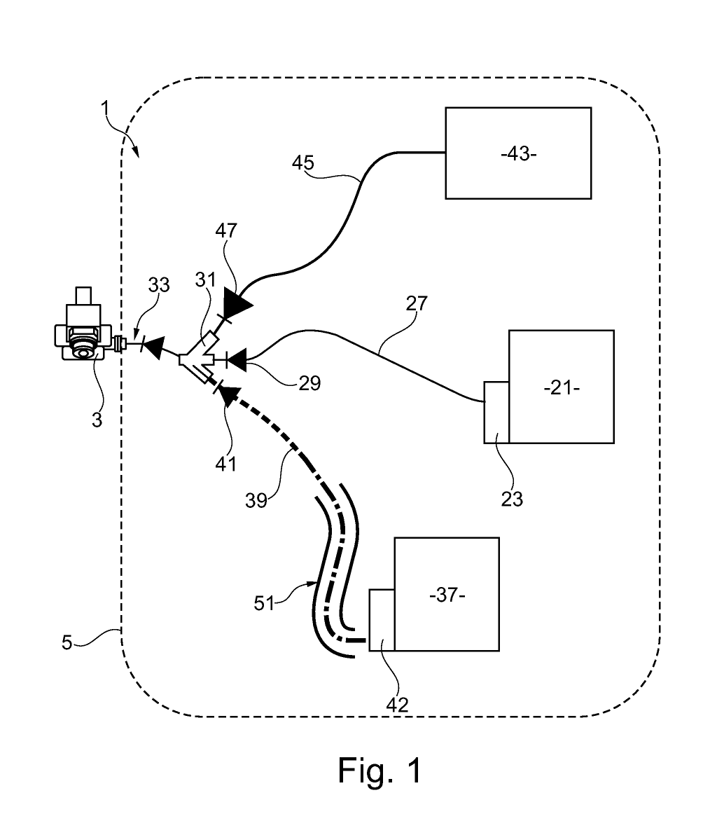

FIG. 1 shows a simplified diagram of an optical detection system according to a first embodiment,

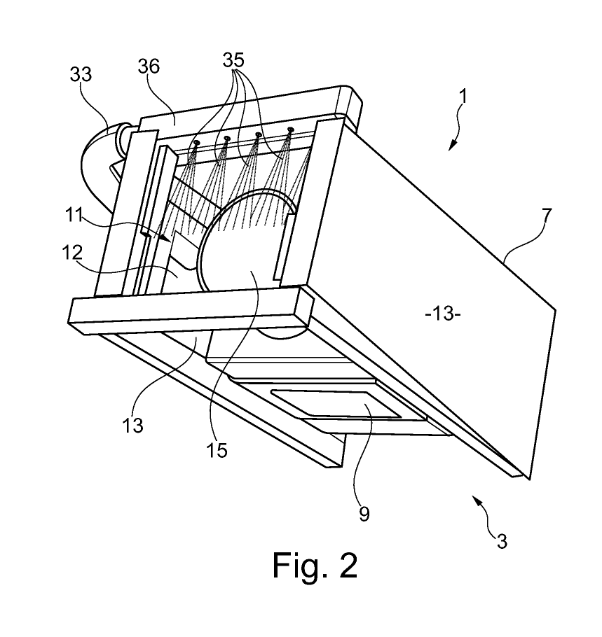

FIG. 2 shows a simplified diagram of an example of a camera module of FIG. 1,

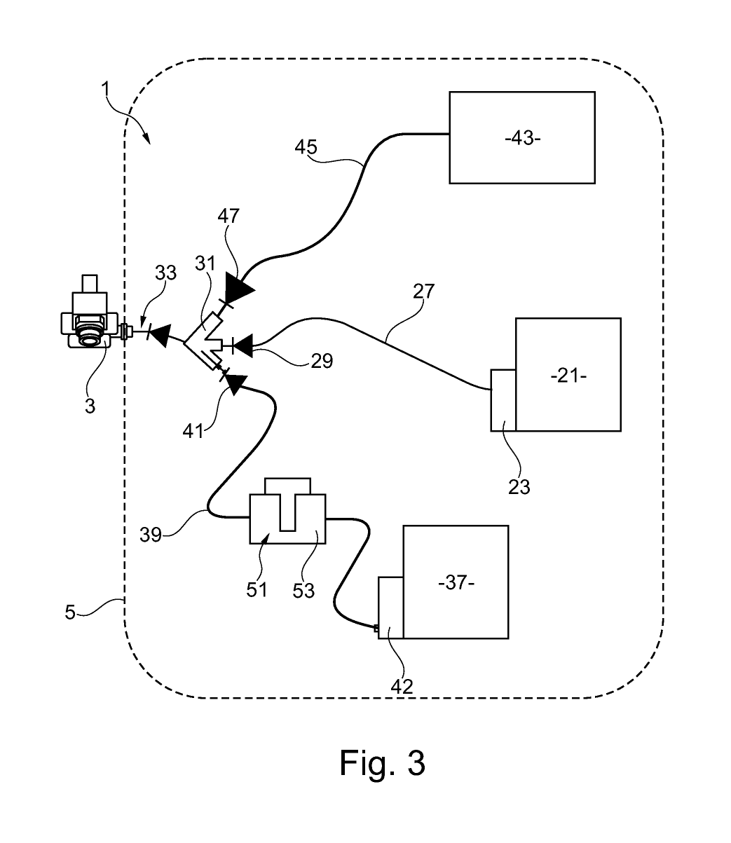

FIG. 3 shows a simplified diagram of an optical detection system according to a second embodiment.

On these figures, the identical elements have the same reference numbers.

The following embodiments are examples. Although the description may refer to one or more embodiments, this does not necessarily mean that each reference relates to the same embodiment, or that the characteristics only apply to one embodiment. Single characteristics of different embodiments can also be combined to provide other embodiments.

In the description, the terms “upstream” and “downstream” are used in relation to the direction of flow of the fluids in the fluidic conduits. A first element is thus arranged upstream of a second element if the fluid first passes through the first element then through the second element.

FIG. 1 shows a first embodiment of an optical detection system 1 according to the invention for a motor vehicle.

The optical detection system 1 is for example intended to be assembled at the rear of a motor vehicle, for example at a bumper or a license plate (not illustrated). It can also for example be assembled on the sides of the vehicle, for example in replacement of the side rear view mirrors.

The optical detection system 1 comprises an optical sensor module 3, in particular a camera and a system 5 for cleaning the lens of the optical sensor module 3.

As seen on FIG. 2, the optical sensor module 3, for example a camera module, comprises a housing 7, an optical sensor 9, in particular for taking shots, accommodated in the housing 7 and a lens 11, in particular a protective pane 12, arranged in front of the sensor 9 and forming at least a part of the wall of the housing 7.

The housing 7 encloses the optical sensor 9 in a hermetic and sealed manner. In order better to illustrate the structure of the optical sensor module 3, only the protective pane 12 and the side walls 13 have been illustrated. The bottom wall of the housing 7 has not been illustrated in order to be able better to illustrate the interior of the module 3 with the optical sensor 9.

The protective pane 11 can be made in glass or crystal polycarbonate.

The optical sensor 9 is for example a CCD sensor (charged coupled device, namely a device for transferring a charge) or a CMOS sensor consisting of a matrix of miniature photodiodes. According to another variant, it can be a LIDAR sensor.

The lens 11 additionally includes for example a convex lens 15 (curved) such as a fish eye lens.

The lens 11 generally comprises any optical element such as for example the protective pane 12 and the lens 15, the optical element being arranged in front of the sensor 9. In certain conditions, there is no protective pane and this function is provided by the lens 15 fastened in a sealed manner to the housing 7.

The optical sensor 9 is installed in the module 3 so as to point through said protective pane 12.

As seen on FIG. 1, the cleaning system 5 comprises at least one main reservoir 21 of a washing liquid. Washing liquid means for example a mixture of solvents, surface active agents, coloring and/or perfuming agents.

The main reservoir 21 also has a washing pump 23 in order to pump the washing liquid towards an outlet which is connected to a conduit 27, for example, a rubber tube, in which a non-return valve 29 is arranged.

The main reservoir 21 is preferably the reservoir of washing liquid which also serves to clean the windshield and the rear window of the vehicle. In this case, the use of a controlled solenoid valve (not illustrated) is envisaged which allows the washing liquid to be guided either towards the windshield or towards the rear window or towards the optical sensor module 3.

The conduit 27 is connected to an inlet of a three-way connector 31 whose outlet is connected to a connection conduit 33 connected to the optical sensor module 3, and more precisely to at least one spray nozzle 35, in the present case, a rail 36 comprising five spray nozzles 35.

The cleaning system 5 furthermore comprises an additional reservoir 37 of a rinsing liquid. The rinsing liquid comprises surface active agents or surfactants which reduce the adhesion strength of the water on the glass surface. It allows drops of water to be evacuated without leaving marks.

The additional reservoir 37 is arranged in parallel with the main reservoir 21 and is connected via a conduit 39, wherein a non-return valve 41 is arranged, to an inlet of the three-way connector 31 and is therefore also connected to the spray nozzles 35. The additional reservoir 37 also has a pump 42 for spraying rinsing water through the spray nozzles 35.

Thus, by spraying a rinsing liquid after spraying a washing liquid, the residues of the washing liquid, the marks and the drops are eliminated. Spraying the rinsing liquid makes it possible to ensure a clean surface of the protective pane 11 and to make the optical sensor module 3 rapidly operable.

As seen on FIG. 1, in an optional manner, the cleaning system 5 can furthermore comprise an air compressor 43 whose outlet is also connected via a conduit 45, wherein a non-return valve 47 is arranged, to an inlet of the three-way connector 31 and is therefore also connected to the spray nozzles 35. In the present case, the compressor 43 can be small in size, even very small in size, which limits its cost as well as the noise it can generate. In effect, its function is more to blow air onto the pane to accelerate the evaporation of the rinsing liquid and not to chase away drops on the protective pane 12.

According to another optional variant, it is envisaged to equip the optical detection system 1 with at least one means 51 for heating the rinsing liquid.

According to the embodiment of FIG. 1, the heating means 51 is for example arranged in the fluidic conduit 39 or at least in a section thereof.

In this case, the fluidic conduit 39 is for example, as diagrammatically shown on FIG. 1, embodied in an elastomer material and comprises at least one resistive wire, integrated at least in a longitudinal portion of the elastomer material of the fluidic conduit 39 and forming the means 51 for heating the rinsing liquid.

Heating the rinsing liquid makes it possible to optimize its chemical properties, in particular its ability to slide over the glass and to assist the evaporation of the rinsing liquid.

According to an embodiment not illustrated, it is also possible to envisage heating the rinsing liquid by arranging an immersion heater as heating means directly in the additional reservoir 37.

FIG. 3 shows yet another embodiment which differs from that of FIG. 1 by the heating means 51.

In effect, in this embodiment, an intermediate reservoir 53 is envisaged, an inlet of which is connected to an outlet of said additional reservoir 37 and an outlet of which is connected to the three-way connector 31 and therefore to the spray nozzles 35. The intermediate reservoir 53 is smaller in size than the additional reservoir 37 so that the quantity of liquid to heat is more limited and the heating means 51, for example an immersion heater or a ceramic heater, is arranged in said intermediate reservoir 53. This makes it possible to reduce the consumption of electrical energy.

The optical detection system 1 is cleaned according to the following process: according to a first step, a washing liquid is sprayed onto the lens of the optical sensor module 3 to remove all the dirt from the protective pane 12. Then, according to a second step, a rinsing liquid is sprayed onto the protective pane 12 to eliminate the remaining drops of the washing liquid. In order to optimize its action, the rinsing liquid can be heated for example to a temperature comprised between 60° C. and 80° C.

In an optional manner, it is possible according to a third step to blow air over the protective pane 12 to accelerate the evaporation of the rinsing liquid.

1. An optical detection system for a motor vehicle, comprising:
an optical sensor module;
a system for cleaning the optical sensor module including at least one main reservoir of a washing liquid and at least one spray nozzle of a liquid connected to said main reservoir; and
an additional reservoir of a rinsing liquid arranged in parallel with the main reservoir and fluidically connected to said at least one spray nozzle.

2. The optical detection system as claimed in claim 1, wherein the rinsing liquid comprises surface active agents or surfactants.

3. The optical detection system as claimed in claim 1, further comprising an air compressor whose outlet is also connected via a conduit to said at least one spray nozzle.

4. The optical detection system as claimed in claim 1, further comprising at least one means for heating the rinsing liquid.

5. The optical detection system as claimed in claim 4, wherein the heating means is arranged in said additional reservoir of the rinsing liquid.

6. The optical detection system as claimed in claim 4, further comprising an intermediate reservoir an inlet of which is connected to an outlet of said additional reservoir and an outlet of which is connected to said at least one spray nozzle, the intermediate reservoir being smaller in size than the additional reservoir and in that the heating means is arranged in said additional reservoir.

7. The optical detection system as claimed in claim 4, wherein the heating means comprises an immersion heater.

8. The optical detection system as claimed in claim 4, wherein the heating means is arranged in a fluidic conduit connecting the additional reservoir to said at least one spray nozzle.

9. The optical detection system as claimed in claim 8, wherein the fluidic conduit connecting the additional reservoir to said at least one spray nozzle is embodied in an elastomer material and comprises at least one resistive wire integrated at least in a longitudinal portion of the elastomer material of the fluidic conduit and forming the means for heating the liquid circulating in the fluidic conduit.

10. A method for cleaning the lens of an optical detection system as claimed in claim 1, comprising:
spraying a washing liquid onto the lens of the optical sensor module; and
spraying a rinsing liquid onto the lens of the optical sensor module.
